(19) United States
(12) Patent Application Publication
(10) Pub. No.: US 2021/0058580 A1
(43) Pub. Date: Feb. 25, 2021

(54) IMAGING SYSTEMS AND METHODS FOR PERFORMING FLOATING GATE READOUT VIA DISTRIBUTED PIXEL INTERCONNECTS FOR ANALOG DOMAIN REGIONAL FEATURE EXTRACTION

(71) Applicant: SEMICONDUCTOR COMPONENTS INDUSTRIES, LLC, Phoenix, AZ (US)

(72) Inventor: Roger PANICACCI, Los Gatos, CA (US)

(73) Assignee: SEMICONDUCTOR COMPONENTS INDUSTRIES, LLC, Phoenix, AZ (US)

(21) Appl. No.: 15/929,733

(22) Filed: May 19, 2020

Related U.S. Application Data
(60) Provisional application No. 62/889,630, filed on Aug. 21, 2019.

(51) Int. Cl. H04N 5/369; H04N 5/378

(52) U.S. Cl. CPC H04N 5/379; H04N 5/378

(57) ABSTRACT

Imaging circuitry may include circuits for implementing feature extraction. The imaging circuitry may include pixels configured to generate pixel values. The pixel values may be optionally scaled by kernel weighting factors. The pixels may be coupled together via a source follower drain path, and a source follower gate in one of the pixels may be selected for readout by coupling that source follower gate to an integrator circuit to compute a feature result. Multiple feature results may be computed successively to detect an event change in either the digital domain or the analog domain. Such feature detection schemes may be applied to detect horizontally-oriented features, vertically-oriented features, diagonally-oriented features, or irregularly shaped features.

This application claims the benefit of provisional patent application No. 62/889,630, filed Aug. 21, 2019, which is hereby incorporated by reference herein in its entirety.

### BACKGROUND

This relates generally to imaging devices, and more particularly, to imaging devices having image sensor pixels on wafers that are stacked on other image readout/signal processing wafers.

Image sensors are commonly used in electronic devices such as cellular telephones, cameras, and computers to capture images. In a typical arrangement, an image sensor includes an array of image pixels arranged in pixel rows and pixel columns. Circuitry may be coupled to each pixel column for reading out image signals from the image pixels.

Imaging systems may implement convolutional neural networks (CNN) to perform feature extraction (i.e., to detect one or more objects, shapes, edges, or other scene information in an image). Feature extraction can be performed in a smaller region of interest (ROI) having a lower resolution than the entire pixel array. Typically, the analog pixel values in the lower resolution ROI are read out, digitized, and stored for subsequent processing for feature extraction and convolution steps.

### BRIEF DESCRIPTION OF THE DRAWINGS

FIG. 1 is a diagram of an illustrative electronic device having an image sensor and processing circuitry for capturing images using an array of image pixels in accordance with some embodiments.

FIG. 2 is a diagram of an illustrated stacked imaging system in accordance with an embodiment.

FIG. 3 is a diagram of an illustrative image sensor array coupled to digital processing circuits and analog processing circuits in accordance with an embodiment.

FIG. 4 is a diagram showing how an image pixel may be connected to a particular region of interest (ROI) via various switch networks in accordance with an embodiment.

FIG. 5 is a diagram showing how a convolution kernel may be applied to an ROI to extract features in accordance with an embodiment.

FIG. 6A is a circuit diagram showing how charge associated with a group of pixels can be sensed via floating source follower gates in accordance with an embodiment.

FIG. 6B is a timing diagram illustrating consecutive feature extractions to detect an event change in accordance with an embodiment.

FIG. 6C is a flow chart of illustrative steps for operating the pixel circuitry of FIG. 6A in accordance with an embodiment.

FIG. 6D is a timing diagram illustrating detection of feature changes in the analog domain in accordance with an embodiment.

FIG. 6 E is a flow chart of illustrative steps for performing the analog domain feature change detection of FIG. 6D in accordance with an embodiment.

FIG. 7A is a diagram showing how charge can be sensed by directly connecting the integrator to the source follower drain terminals in accordance with an embodiment.

FIG. 7B is a diagram showing an illustrative differential readout configuration for positive and negative weighted pixel values in accordance with an embodiment.

FIG. 8A is diagram illustrating how pixel tiles may be coupled to corresponding ROI control logic within a stacked analog feature extraction die in accordance with an embodiment.

FIG. 8B is a diagram illustrating how pixel row control lines and column output lines may be coupled to ROI control logic within the stacked analog feature extraction die in accordance with an embodiment.

FIG. 8C is a diagram of an illustrative 8×8 pixel cluster in accordance with an embodiment.

FIG. 8D is a diagram of an illustrative ROI unit cell that includes four pixel clusters in accordance with an embodiment.

FIG. 8E is a diagram of another ROI cell formed at the bottom of each pixel column in accordance with an embodiment.

FIG. 9A is a diagram illustrating how row and column ROI selection can be controlled using row and column shift registers in accordance with an embodiment.

FIG. 9B is a diagram illustrating how row and column ROI selection can be configured to support horizontal feature signal detection in accordance with an embodiment.

FIG. 9C is a diagram illustrating exemplary shapes that can be detected using the ROI selection scheme of FIG. 9B in accordance with an embodiment.

FIG. 9D is a diagram illustrating how row and column ROI selection can be configured to support vertical feature signal detection in accordance with an embodiment.

FIG. 9E is a diagram illustrating exemplary shapes that can be detected using the ROI selection scheme of FIG. 9D in accordance with an embodiment.

FIG. 9F is a diagram illustrating how row and column ROI selection can be configured to support a +45° diagonal feature signal detection in accordance with an embodiment.

FIG. 9G is a diagram illustrating exemplary shapes that can be detected using the ROI selection scheme of FIG. 9F in accordance with an embodiment.

FIG. 9H is a diagram illustrating how row and column ROI selection can be configured to support a −45° diagonal feature signal detection in accordance with an embodiment.

FIG. 9I is a diagram illustrating exemplary shapes that can be detected using the ROI selection scheme of FIG. 9H in accordance with an embodiment.

FIG. 9J is a diagram illustrating how row and column ROI selection can be configured to detect a predetermined shape in accordance with an embodiment.

FIG. 9K is a diagram illustrating exemplary shapes that can be detected using the ROI selection scheme of FIG. 9J in accordance with an embodiment.

### DETAILED DESCRIPTION

Electronic devices such as digital cameras, computers, cellular telephones, and other electronic devices may include image sensors that gather incoming light to capture an image. The image sensors may include arrays of image pixels. The pixels in the image sensors may include photosensitive elements such as photodiodes that convert the incoming light into image signals. Image sensors may have any number of pixels (e.g., hundreds or thousands or more). A typical image sensor may, for example, have hundreds of thousands or millions of pixels (e.g., megapixels). Image sensors may include control circuitry such as circuitry for operating the image pixels and readout circuitry for reading out image signals corresponding to the electric charge generated by the photosensitive elements.

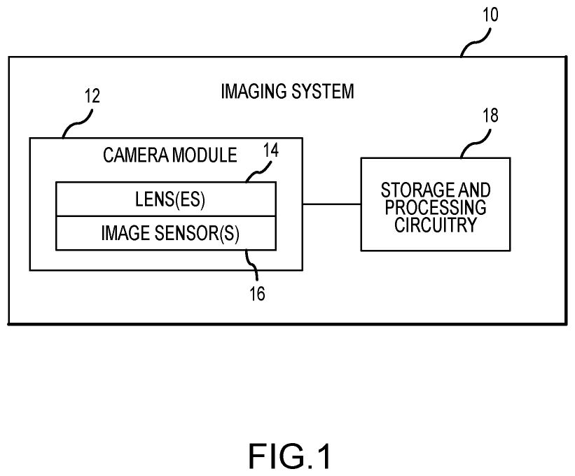

FIG. 1 is a diagram of an illustrative imaging system such as an electronic device that uses an image sensor to capture images. Electronic device 10 of FIG. 1 may be a portable electronic device such as a camera, a cellular telephone, a tablet computer, a webcam, a video camera, a video surveillance system, an automotive imaging system, a video gaming system with imaging capabilities, or any other desired imaging system or device that captures digital image data. Camera module 12 may be used to convert incoming light into digital image data. Camera module 12 may include one or more lenses 14 and one or more corresponding image sensors 16. Lenses 14 may include fixed and/or adjustable lenses and may include microlenses formed on an imaging surface of image sensor 16. During image capture operations, light from a scene may be focused onto image sensor 16 by lenses 14. Image sensor 16 may include circuitry for converting analog pixel data into corresponding digital image data to be provided to storage and processing circuitry 18. If desired, camera module 12 may be provided with an array of lenses 14 and an array of corresponding image sensors 16.

Storage and processing circuitry 18 may include one or more integrated circuits (e.g., image processing circuits, microprocessors, storage devices such as random-access memory and non-volatile memory, etc.) and may be implemented using components that are separate from camera module 12 and/or that form part of camera module 12 (e.g., circuits that form part of an integrated circuit that includes image sensors 16 or an integrated circuit within module 12 that is associated with image sensors 16). Image data that has been captured by camera module 12 may be processed and stored using processing circuitry 18 (e.g., using an image processing engine on processing circuitry 18, using an imaging mode selection engine on processing circuitry 18, etc.). Processed image data may, if desired, be provided to external equipment (e.g., a computer, external display, or other device) using wired and/or wireless communications paths coupled to processing circuitry 18.

In accordance with an embodiment, groups of pixel values in the analog domain may be processed to extract features associated with objects in a scene. The pixel information is not being digitized from a low resolution region of interest. The feature information extracted from a pixel array can be processed in multiple steps of a convolutional neural network (as an example) using this analog implementation to identify scene information for the system, which can then be used to decide whether or not to output pixel information at a higher resolution in that region of the scene.

Die stacking may be leveraged to allow the pixel array to connect to corresponding region of interest (ROI) processors to enable efficient analog domain feature extraction (e.g., to detect object features of interest and temporal changes for areas of the array that are not being read out at full resolution through the normal digital signal processing path). Extracted features may be temporarily stored in the analog domain, which can be used to check for changes in feature values over time and to detect changes in key features related to objects in the scene.

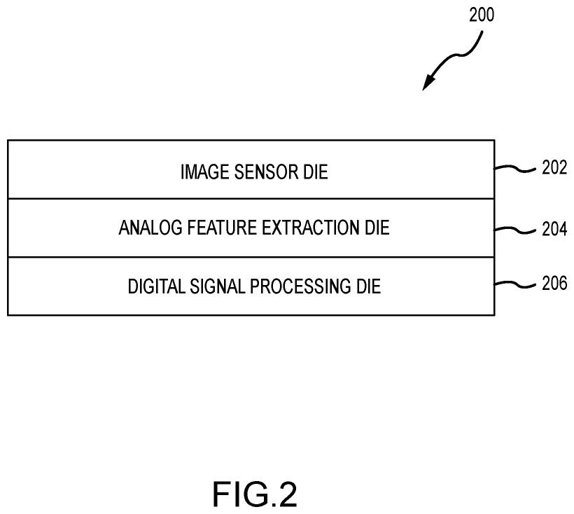

FIG. 2 is a diagram of an illustrated stacked imaging system 200. As shown in FIG. 2, system 200 may include an image sensor die 202 as the top die, a digital signal processor die 206 as the bottom die, and an analog feature extraction die 204 that is stacked vertically between top die 202 and bottom die 206. The array of image sensor pixels reside within the top image sensor die 202; the normal digital readout circuits reside within the bottom die 206; and the analog domain feature extraction circuitry are formed within the middle die 204. If desired, other ways of stacking the various imager dies may also be used.

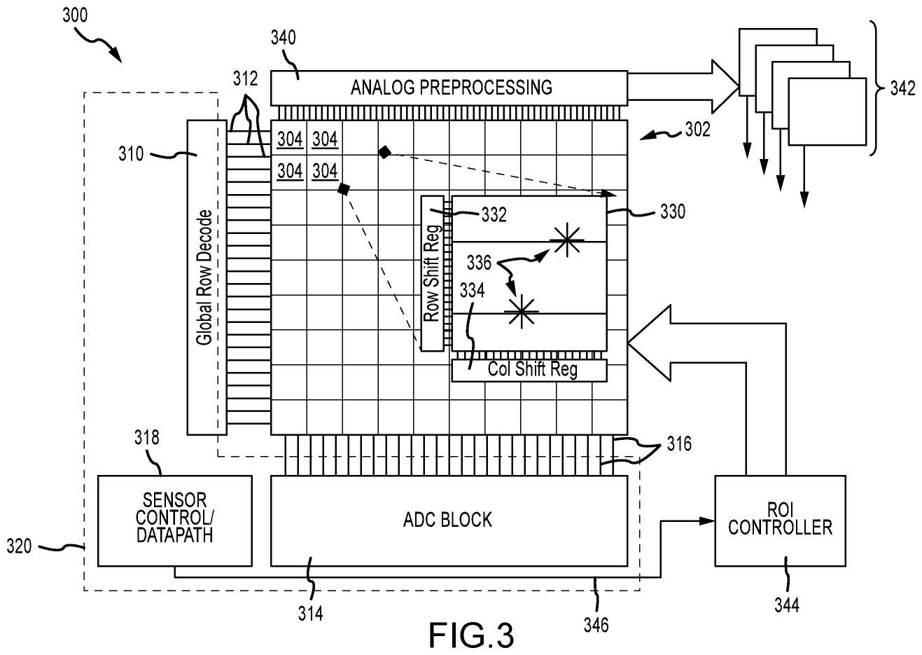

FIG. 3 is a diagram of an illustrative image sensor array 302 coupled to digital processing circuits and analog processing circuits. The digital signal processing circuits are delineated by dotted box 320, which include a global row decoder 310 configured to drive all the pixel rows within array 302 via row control lines 312, an analog-to-digital converter (ADC) block 314 configured to receive pixels values via each pixel column through the normal readout paths 316, and a sensor controller 318. These digital signal processing circuits 320 may reside within the bottom die 206 (see FIG. 2).

The image pixel array 302 may be formed on the top image sensor die 202. Pixel array 302 may be organized into groups sometimes referred to as “tiles” 304. Each tile 304 may, for example, include 256×256 image sensor pixels. This tile size is merely illustrative. In general, each tile 304 may have a square shape, a rectangular shape, or an irregular shape of any suitable dimension (i.e., tile 304 may include any suitable number of pixels).

Each tile 304 may correspond to a respective “region of interest” (ROI) for performing feature extraction. A separate ROI processor 330 may be formed in the analog die 204 below each tile 304. Each ROI processor 330 may include a row shifter register 332, a column shift register 336, and row control and switch matrix circuitry for selectively combining the values from multiple neighboring pixels, as represented by converging lines 336. Signals read out from each ROI processor 330 may be fed to analog processing and multiplexing circuit 340 and provided to circuits 342. Circuits 342 may include analog filters, comparators, high-speed ADC arrays, etc. Sensor control 318 may send signals to ROI controller 344, which controls how the pixels are read out via the ROI processors 330. For example, ROI controller 344 may optionally control pixel reset, pixel charge transfer, pixel row select, pixel dual conversion gain mode, a global readout path enable signal, a local readout path enable signal, switches for determining analog readout direction, ROI shutter control, etc. Circuits 330, 340, 342, and 344 may all be formed within the analog die 204.

An imaging system configured in this way may support content aware sensing. The analog readout path supports rapid scanning for shape/feature detection, non-destructive intensity thresholding, temporal events, and may also use on-board vision smart components to process shapes. The high-speed ROI readout path can also allow for digital accumulation and burst readout without impact to the normal frame readout. This content aware sensor architecture reads out different regions at varying resolutions (spatial, temporal, bit depth) based on the importance of that part of the scene. Smart sensors are used to monitor activity/events in regions of the image that are not read out at full resolution to determine when to wake up that region for higher resolution processing. The analog feature extraction supports monitoring of activity in those particular regions of interest without going into the digital domain. Since the analog feature extraction does not require processing through an ADC, a substantial amount of power can be saved.

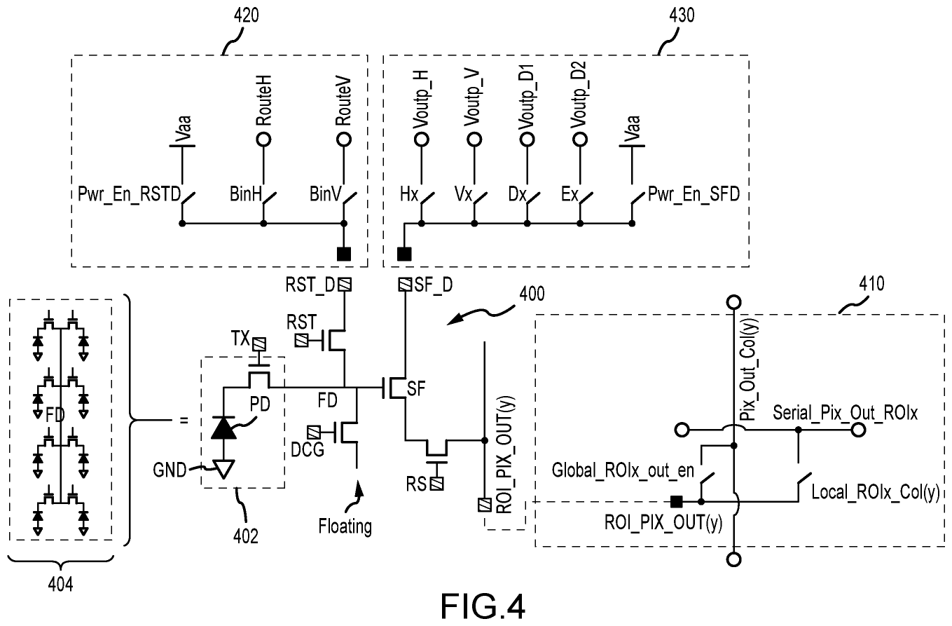

FIG. 4 is a diagram showing how an image pixel may be connected to a particular region of interest (ROI) via various switch networks. As shown in FIG. 4, an image sensor pixel such as pixel 400 may include a photodiode PD coupled to a floating diffusion node FD via a charge transfer transistor, a reset transistor coupled between the FD node and a reset drain node RST_D (sometimes referred to as a reset transistor drain terminal), a dual conversion gain (DCG) transistor having a first terminal connected to the FD node and a second terminal that is electrically floating, a source follower transistor with a drain node SF_D, a gate terminal connected to the FD node, and a source node coupled to the ROI pixel output line via a corresponding row select transistor. If desired, the DCG switch may optionally be coupled to a capacitive circuit (e.g., a fixed capacitor or a variable capacitor bank) for charge storage purposes or to provide additional gain/weighting capability. Portion 402 of pixel 400 may alternatively include multiple photodiodes that share a single floating diffusion node, as shown by configuration 404.

In one suitable arrangement, each reset drain node RST_D within an 8×8 pixel cluster may be coupled to a group of reset drain switches 420. This is merely illustrative. In general, a pixel cluster that share switches 420 may have any suitable size and dimension. Switches 420 may include a reset drain power enable switch that selectively connects RST_D to positive power supply voltage Vaa, a horizontal binning switch BinH that selectively connects RST_D to a corresponding horizontal routing line RouteH, a vertical binning switch BinV that selectively connects RST_D to a corresponding vertical routing line RouteV, etc. Switch network 420 configured in this way enables connection to the power supply, binning charge from other pixels, focal plane charge processing.

Each source follower drain node SF_D within the pixel cluster may also be coupled to a group of SF drain switches 430. Switch network 430 may include a SF drain power enable switch Pwr_En_SFD that selectively connects SF_D to power supply voltage Vaa, switch Hx that selectively connects SF_D to a horizontal line Voutp_H, switch Vx that selectively connects SF_D to a vertical line Voutp_V, switch Dx that selectively connects SF_D to a first diagonal line Voutp_D1, switch Ex that selectively connects SF_D to a second diagonal line Voutp_D2, etc. Switches 430 configured in this way enables the steering of current from multiple pixel source followers to allow for summing/differencing to detect shapes and edges and connection to a variable power supply.

Each pixel output line ROI_PIX_OUT(y) within the pixel cluster may also be coupled to a group of pixel output switches 410. Switch network 410 may include a first switch Global_ROIx_out_en for selectively connecting the pixel output line to a global column output bus Pix_Out_Col(y) and a second local switch Local_ROIx_Col(y) for selectively connecting the pixel output line to a local ROI serial output bus Serial_Pix_Out_ROIx that can be shared between different columns. Configured in this way, switches 410 connects each pixel output from the ROI to one of the standard global output buses for readout, to a serial readout bus to form the circuit used to detect shapes/edges, to a high speed local readout signal chain, or to a variable power supply.

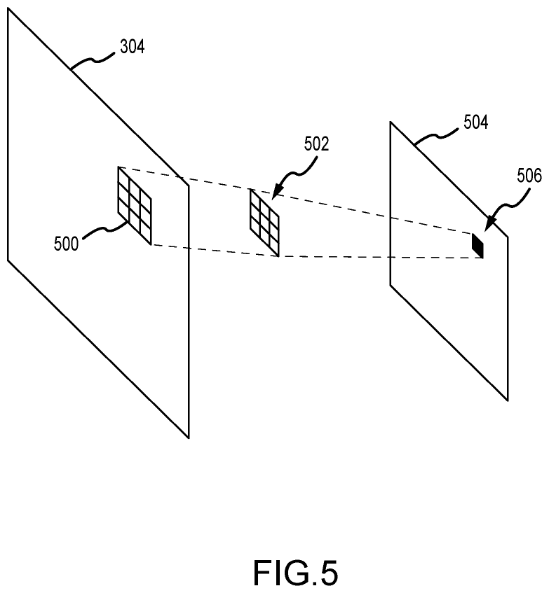

Machine vision applications use algorithms to find features and objects using fundamental operations that weigh groups of pixels and sum them together. FIG. 5 is a diagram showing how a convolution kernel 502 may be applied to a tile 304 or ROI to extract features 506. Convolution kernel 502 may include a collection of weights. Convolution kernel 502 may be applied to a corresponding window 500 sliding across ROI 304. In the example of FIG. 5, kernel 502 is shown as a 3×3 matrix. This is, however, merely illustrative. Kernel 502 may be a 5×5 array of weights or a matrix of any suitable size or dimension. Each weight can either be positive or negative. Each kernel window 500 performs an analog multiply accumulate (MAC) operation (e.g., using 2 dimensional matrix multiplications) to obtain a resulting convolution feature 506. Multiple convolution features 506 may be combined into a feature map 504 that is the same size or optionally smaller than tile 304. Other ways of generating CNN layers may also be implemented.

The convolution operation illustrated in FIG. 5 is conventionally performed in the digital domain using digital values. In accordance with an embodiment, the MAC operations may be performed in the analog domain to reduce the need for excessive analog-to-digital conversion (which can save power) and to reduce the need for high bandwidth digital bus structures. A configurable bus switch connection network may be used to connect large groups of pixel in various ways to check edges, shapes, or features in one or more regions of interest. Analog pixels values gathered from floating diffusions nodes in a distributed network of pixels can then be used to detect changes in these features over time to act like a feature “event” detector. As an example, the source follower in each pixel can serve as a capacitive sensing device rather than using current from the source follower to save power.

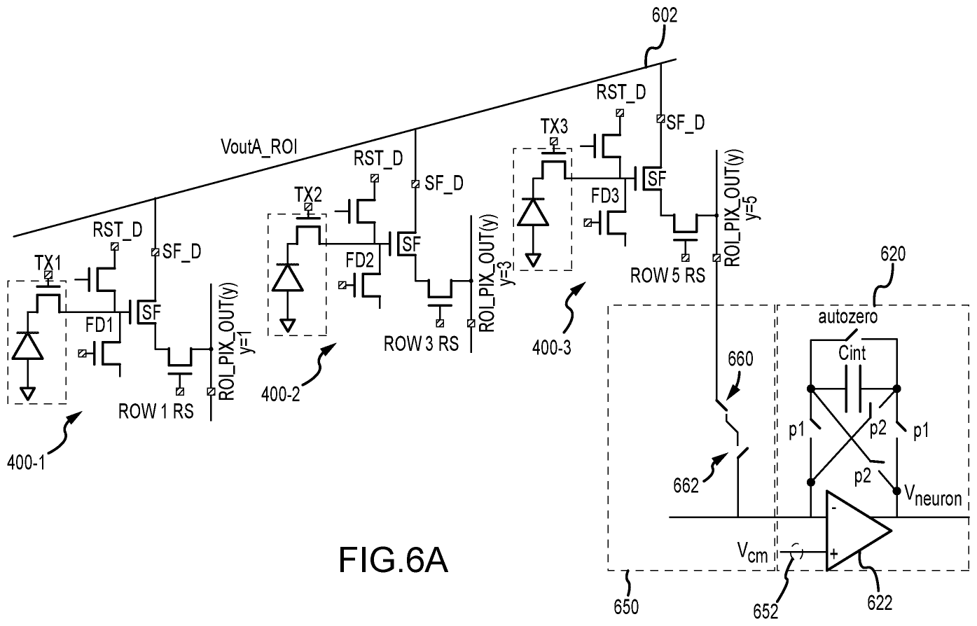

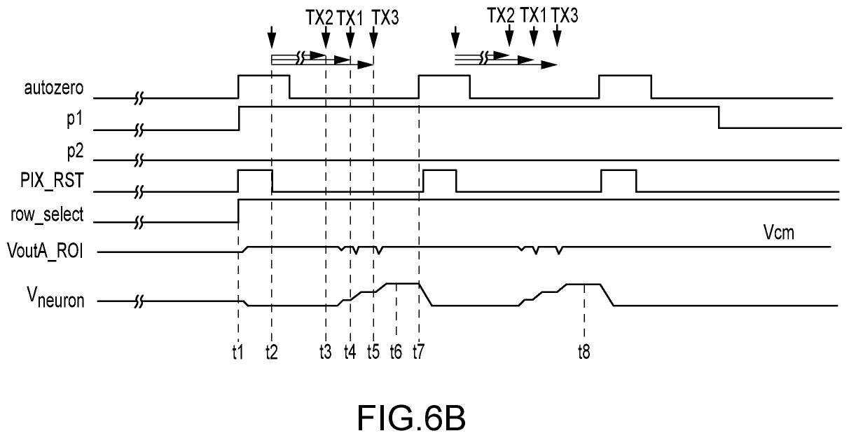

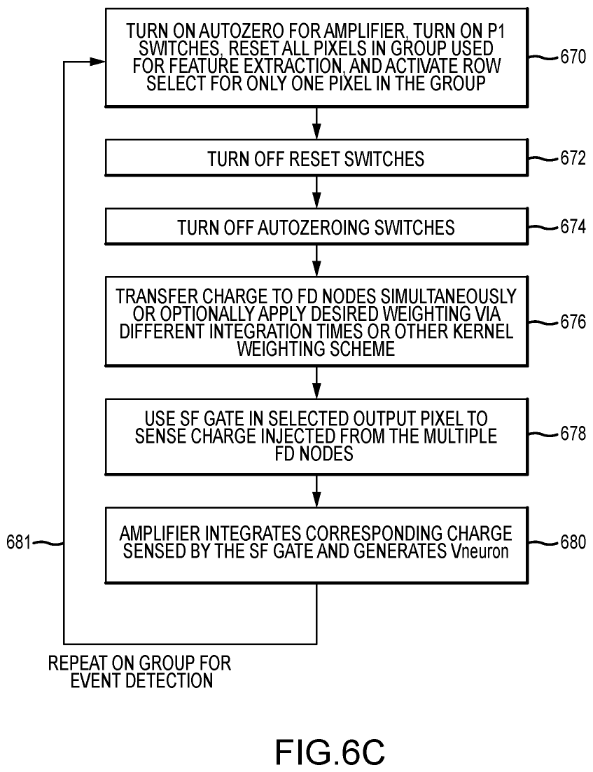

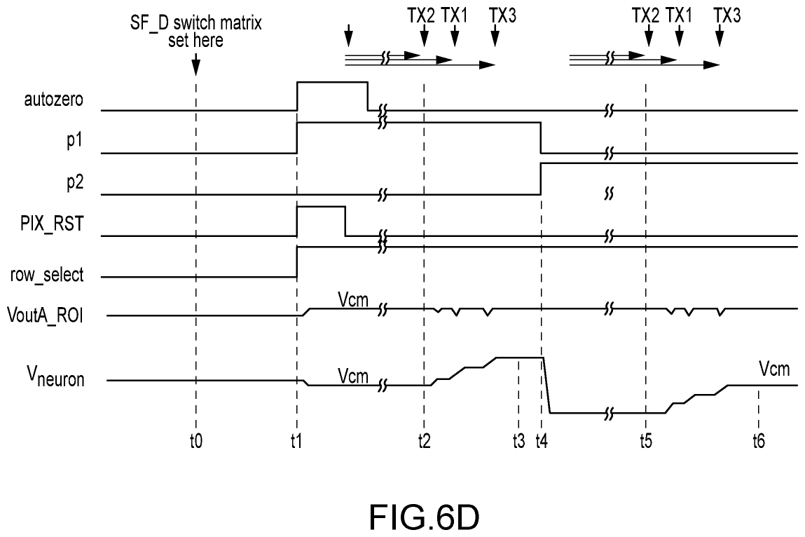

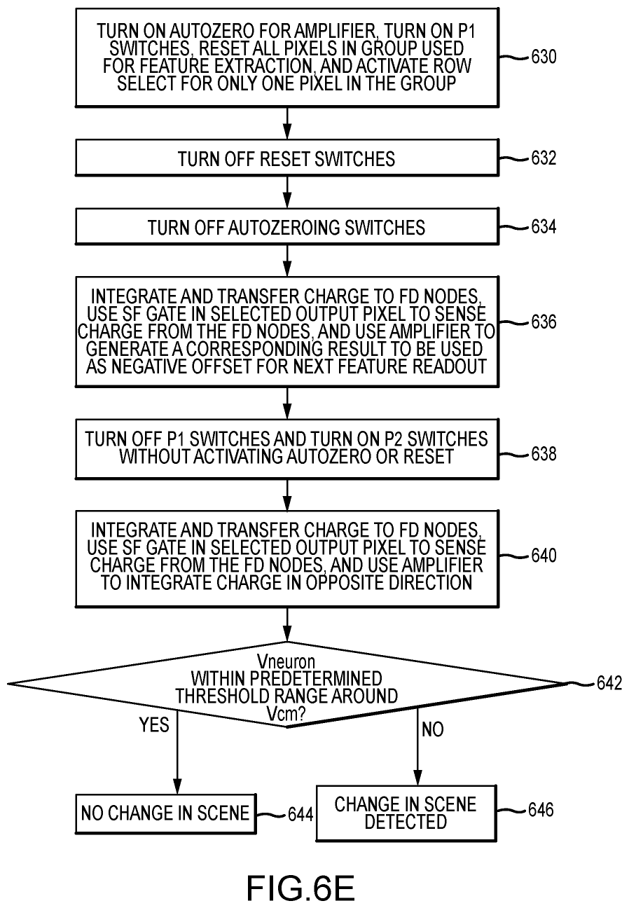

FIG. 6A is a diagram showing how charge (voltage) can be sensed across multiple floating source follower gates (via the gate to channel capacitance in strong inversion and gate to drain/gate to source overlap capacitances) when charge is added to different floating diffusion nodes in accordance with an embodiment. As shown in FIG. 6A, the SF_D nodes of pixel 400-1 (e.g., a first pixel in row 1 and column 1), pixel 400-2 (e.g., a second pixel in row 3 and column 3), and pixel 400-3 (e.g., a third pixel in row 5 and column 5) may all be connected together to path 602 (e.g., and SF_D output path on which voltage VoutA_ROI is generated) by configuring the appropriate ROI routing switches on the intermediate analog die. Path 602 may sometimes be referred to as a charge sensing line. The RST_D nodes may be electrically floating or may be coupled to positive power supply voltage VAA (e.g., by selective disabling or enabling one or more switches 420 in FIG. 4). This example in which pixels 400-1, 400-2, and 400-3 from three different rows/columns are being selected for feature extraction is merely illustrative and is not intended to limit the scope of the present embodiments. In general, any desired group of pixels arranged in the same row or different rows or in the same column or different columns may be sensed simultaneously by shorting together their SF_D terminals via corresponding ROI switches (see, e.g., switches 430 in FIG. 4).

The charge transfer control signals TX1, TX2, and TX3 controlling pixels 400-1, 400-2, and 400-3 respectively may optionally be pulsed at different times to transfer charge with different pixel integration times to set the kernel weight for each pixel. Alternatively, each pixel weight may be set by dynamically programming in an appropriate conversion gain through the DCG transistor (e.g., by coupling the FD diffusion node to adjustable capacitance values). The local bus and/or global bus connection for these pixels may be turned off.

Once charge have been transferred to floating diffusion node FD1 in pixel 400-1, to FD2 in pixel 400-2, and to FD3 in pixel 400-3, the voltage change across the floating gate terminal of the source follower transistor in pixel 400-3 may be capacitively sensed. Transferring charge to FD1 may cause a first amount of voltage change in VoutA_ROI. Transferring charge to FD2 may cause a second amount of voltage change in VoutA_ROI. Transferring charge to FD3 may cause a third amount of voltage change in VoutA_ROI. The total cumulative amount of transferred charge may be sensed by the source follower gates of pixels 400-1, 400-2, 400-3, which act like capacitors connected in parallel to the VoutA_ROI node to sense the collective charge generated from the group of feature extraction pixels. Only one pixel in the group of pixels used for feature extraction may be selected for readout. To perform the readout, the corresponding pixel output line ROI_PIX_OUT(5) may be coupled to integrator block 620 via switch 660 and switch 662. Switch 660 may correspond to the Local_ROIx_Col switch within 410 of FIG. 4. Switch 662 may serve as an additional output selection switch (not shown in FIG. 4) for coupling the serial output bus to integrator block 620. These switches within box 650 and/or the integrator 620 may be formed as part of the intermediate analog feature extraction die 204 (see FIG. 2).

Summing the differently weight pixel values can be done using a switched capacitor integrator block 620. Integrator 620 may include an amplifier 622 having a first (+) input configured to receive common mode input voltage Vcm (see input path 652) and a second (−) terminal coupled to the selected output pixel. A shared integrating capacitor Cint may be selectively cross-coupled across the input/output of amplifier 622 using switches p1 or p2. Integrating capacitor Cint may be reset using an autozeroing switch. A final Vneuron value may be generated at the output of amplifier 622. Integrator 620 configured as such may be referred to as a switch capacitor integrating circuit. The polarity on Cint may be flipped for event detection (assuming the previous result is stored as a negative offset for the next result). Alternatively, nearby pixels may be coupled together with similar values in the same configuration at an earlier time to check for changes in a scene. If desired, other summing mechanisms such as configurations that use a charge domain dynamic capacitor may also be used. Capacitor Cint may also be implemented as a bank of capacitors to allow storing multiple feature information and to compare any changes that might occur over time.

FIG. 6B is a timing diagram illustrating consecutive feature extraction operations for detecting an event change. At time t1, the autozeroing switch may be may turned on to autozero the integrator amplifier, the p1 switches may be turned on, all pixels currently used for feature extraction (which may include pixels from one or more rows) may be reset in parallel, and the row select switch in only one of the pixels in the feature extraction pixel group may be turned on. At time t2, the pixel reset gate may be turned off, which starts the integration time for the various pixels.

In the example of FIG. 6B, variable pixel integration times may be implemented by pulsing the charge transfer gates at different times to apply different kernel weighting factors to each pixel. For instance, TX2 may be pulsed at time t3 to allow charge to flow to FD2, which causes a first amount of voltage change at VoutA_ROI. This first amount of voltage change will result in Vneuron increases from common mode voltage Vcm by a first corresponding amount. Signal TX1 may be pulsed at time t4 to allow charge to flow to FD1, which causes a second amount of voltage change at VoutA_ROI. This second amount of voltage change will result in Vneuron to further increase by a second corresponding amount. Signal TX3 may then be pulsed at time t5 to allow charge to flow to FD3, which causes a third amount of voltage change at VoutA_ROI. This third amount of voltage change will result in Vneuron further increasing by a third corresponding amount. This final value of Vneuron can be sampled at time t6 and can be stored as a first feature result after analog-to-digital conversion.

At time t7, the autozero and reset operations may be performed again to drive Vneuron back to common mode voltage level Vcm. The process described from time t1 to time t6 may be repeated again from time t7 to time t8. At time t8, the final value of Vneuron may be sampled and stored as a second feature result after analog-to-digital conversion. The second stored feature result sampled at time t8 may be compared (in the digital domain) with the first stored feature result sampled at time t6 to determine whether a feature or event change has occurred in the scene.

FIG. 6C is a flow chart of illustrative steps for operating the pixel circuitry of FIG. 6A. At step 670 (corresponding to time t1 in FIG. 6B), the autozero switch for the amplifier is turned on, the p1 switches are turned on, all pixels in the group used for feature extraction may be reset, and the row select switch for only one of the pixel in the group (sometimes referred to as the “selected output pixel”) may be activated for readout.

At step 672 (corresponding to time t2 in FIG. 6B), the reset switches in the pixels may be turned off. At step 674, the autozero switches may then be turned off.

At step 676, charge may be transferred to the floating diffusion nodes simultaneously or optionally at different times (see, e.g., times t3-t5 in FIG. 6B) to apply the desired kernel weighting scheme. If desired, other kernel weighting or gain tuning methodologies may be used within each pixel or upon readout (e.g., using adjustable capacitive circuits, adjustable resistive circuits, adjustable current mirroring schemes, adjustable output selection schemes, etc.).

At step 678, the source follower (SF) transistor in the selected output pixel may be used to simultaneously couple the voltage change from the injected charge on its gate and used as a switch to pass the voltage change resulting from charge injected from the multiple floating diffusion nodes that received charge during step 676. At step 680, the integrating amplifier may be used to integrate the corresponding charge coupled by the source follower gates and to generate output voltage Vneuron. The final Vneuron output level may be a function of the cumulative charge injected by each of the associated floating diffusion nodes. This process may be repeated on the same group of pixels for event detection, as indicated by loopback path 681.

The example of FIGS. 6B-6C in which event detection of feature changes is performed in the digital domain is merely illustrative. FIG. 6D is a timing diagram illustrating detection of feature changes in the analog domain in accordance with another embodiment. At time t0, the SF_D switch matrix for selecting the desired pixels for the feature extraction ROI may be set (e.g., the group of image pixels used for feature exaction may have their SF_D nodes shorted together via the ROI switches 430 shown in FIG. 4).

At time t1, the autozeroing switch may be may turned on to autozero the integrator amplifier, the p1 switches may be turned on, all pixels currently used for feature extraction (which may include pixels from one or more rows) may be reset in parallel, and the row select switch in only one of the pixels in the feature extraction pixel group may be turned on.

In the example of FIG. 6B, variable pixel integration times may be implemented by pulsing the charge transfer gates at different times (starting at time t2) to apply different kernel weighting factors to each pixel. The final corresponding value of Vneuron can be sampled at time t3 and stored on the integrating capacitor Cint as the negative offset for the next feature readout.

At time t4, the p1 switches are turned off while the p2 switches are turned on the flip the polarity of the integrating amplifier. Note that the autozero and reset operations should not be performed here since Cint is storing the previous integrated value. After time t5, charge may be transferred to the multiple floating diffusion nodes. At time t6, the final value of Vneuron may be sampled and checked (in the analog domain) to see if a feature change has occurred.

For instance, if the final Vneuron value is within a threshold range around Vcm (e.g., if the final Vneuron value is less than a predetermined threshold delta above Vcm or greater than a predetermined threshold delta below Vcm), then no change in the scene has been detected. If, however, the final Vneuron value is outside or beyond a threshold range of Vcm (e.g., if the final Vneuron value is more than a predetermined threshold delta above Vcm or less than a predetermined threshold delta below Vcm), then a chance in the scene has been detected. Performing event detection in the analog domain in this way obviates the need to perform conversion, storage, and comparison in the digital domain.

FIG. 6E is a flow chart of illustrative steps for performing the analog domain feature change detection described in connection with FIG. 6D. At step 630 (corresponding to time t1 in FIG. 6D), the autozero switch for the amplifier is turned on, the p1 switches are turned on, all pixels in the group used for feature extraction may be reset, and the row select switch of the selected output pixel may be activated for readout.

At step 632, the reset switches in the pixels may be turned off. At step 634, the autozero switches may then be turned off.

At step 636, the pixels may integrate charge and the integrated charge may be transferred to the floating diffusion nodes simultaneously or optionally at different times to apply the desired kernel weighting scheme. If desired, other kernel weighting or gain tuning methodologies may be used within each pixel or upon readout (e.g., using adjustable capacitive circuits, adjustable resistive circuits, adjustable current mirroring schemes, adjustable output selection schemes, etc.). After charge transfer, the source follower transistor in the selected output pixel may be used to pass the voltage change sensed across the source follower gates from the charge from the multiple floating diffusion nodes. The integrator amplifier may be used to generate and store a corresponding result to be used as the negative offset for the next feature readout.

At step 638 (corresponding to time t4 in FIG. 6D), the p1 switches may be turned off and the p2 switches may be turned on to flip the polarity of the integrator block without activating the autozero and reset switches. Keeping the autozero and reset transistors off prevents the previously stored feature result from getting wiped out.

At step 640, the pixels may integrate charge and the integrated charge may be transferred to the floating diffusion nodes. After charge transfer, the source follower transistor in the selected output pixel may be used to pass the voltage change sensed across the source follower gates from the charge from the multiple floating diffusion nodes. The integrator amplifier may then be used to integrate charge in the opposite direction (relative to the operation of step 636 before the p1 and p2 switches were toggled).

At step 642, a comparator circuit may be used to determine whether the final Vneuron (at time t6 in FIG. 6D) is within a predetermined threshold voltage range around common mode voltage Vcm. In response to using the comparator circuit to determine that Vneuron is within the predetermined threshold voltage range around Vcm, then no change in scene has been detected (result 644). Alternatively, in response to using the comparator circuit to determine that Vneuron is outside the predetermined threshold voltage range about Vcm, then a change in the scene has been detected (result 646).

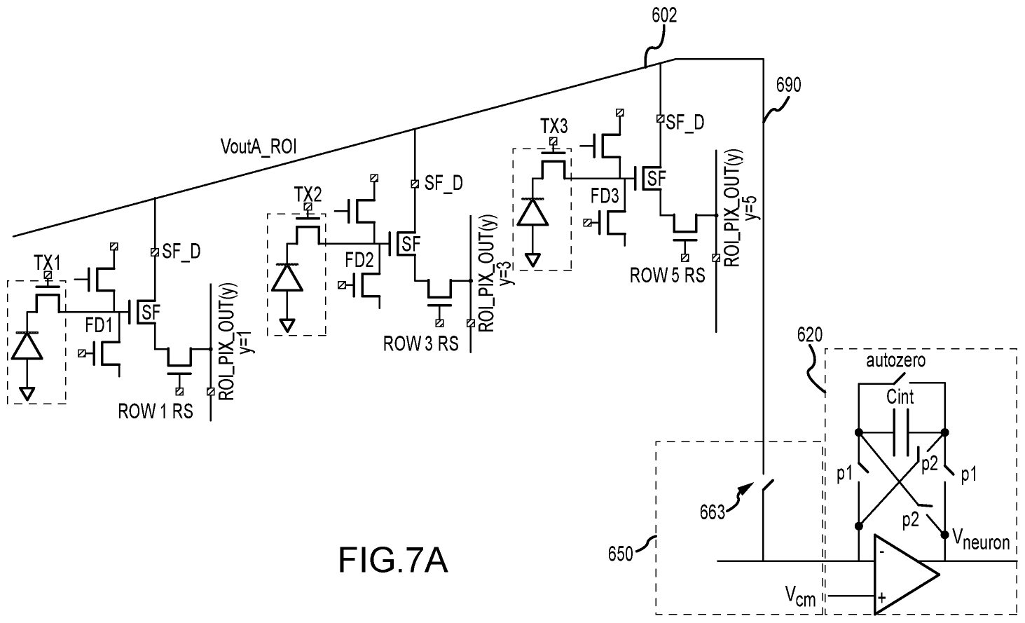

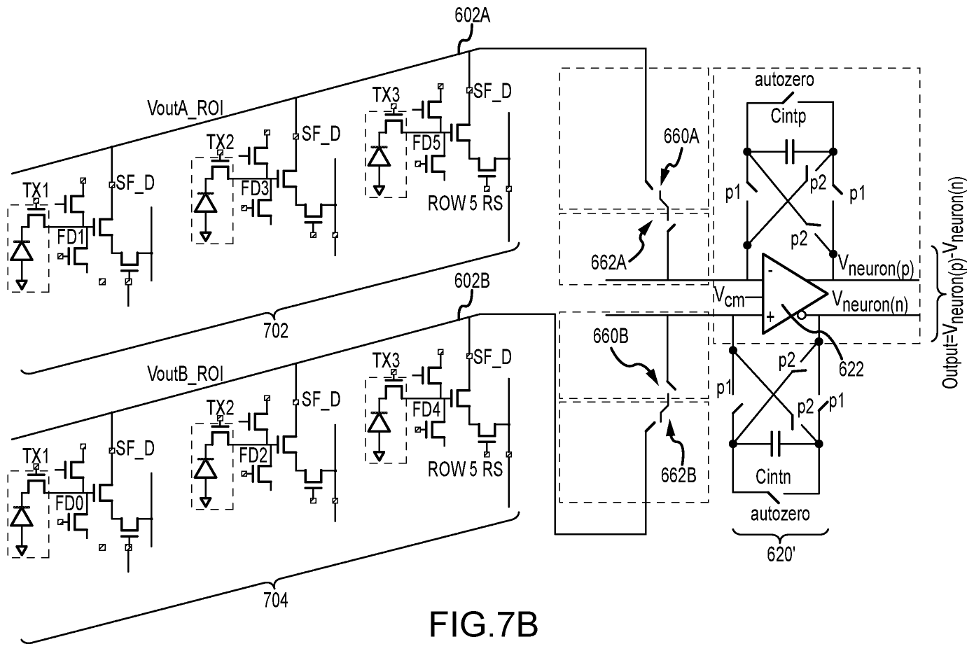

The embodiment of FIG. 6A in which the charge integrator block is coupled to the pixel column line of the selected output pixel is merely illustrative. FIG. 7A illustrates another suitable arrangement showing how voltage can be sensed by directly connecting the integrator block to the shared source follower drain terminals when charge is added to different floating diffusion nodes. As shown in FIG. 7A, the SF_D nodes of pixels 400-1, 400-2, and 400-3 are connected directly to the integrator block 620 via switch 663. Switch 663 within box 650 and/or the switched-capacitor integrator 620 may be formed as part of the intermediate analog feature extraction die 204 (see FIG. 2). Configured in this way, the analog switch network may sense weighted pixel signals directly from the source follower drain terminal. The ROI switch network may be used to connect together groups of pixels over large areas or regions to detect structures like edges and/or other features.

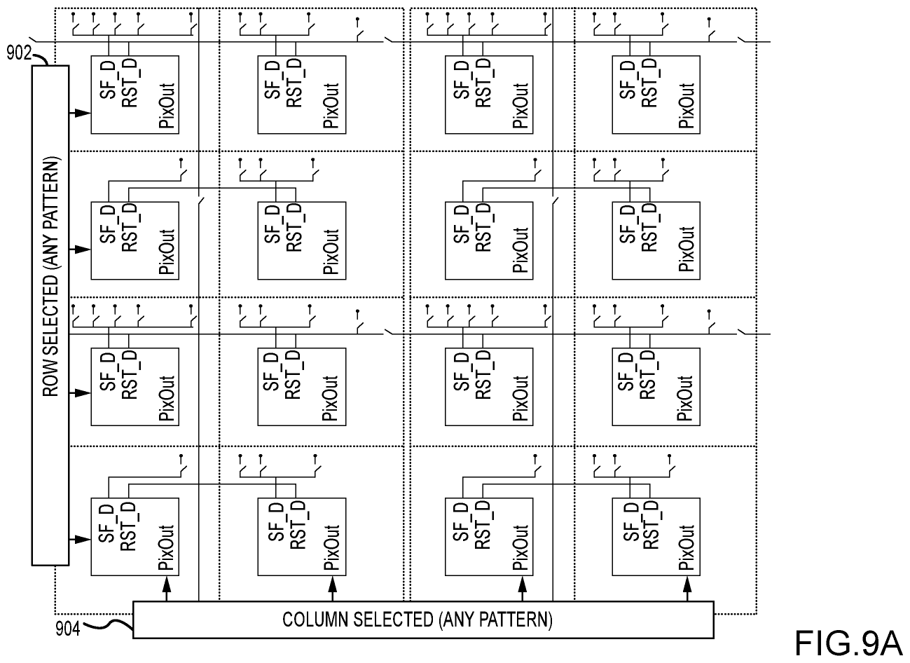

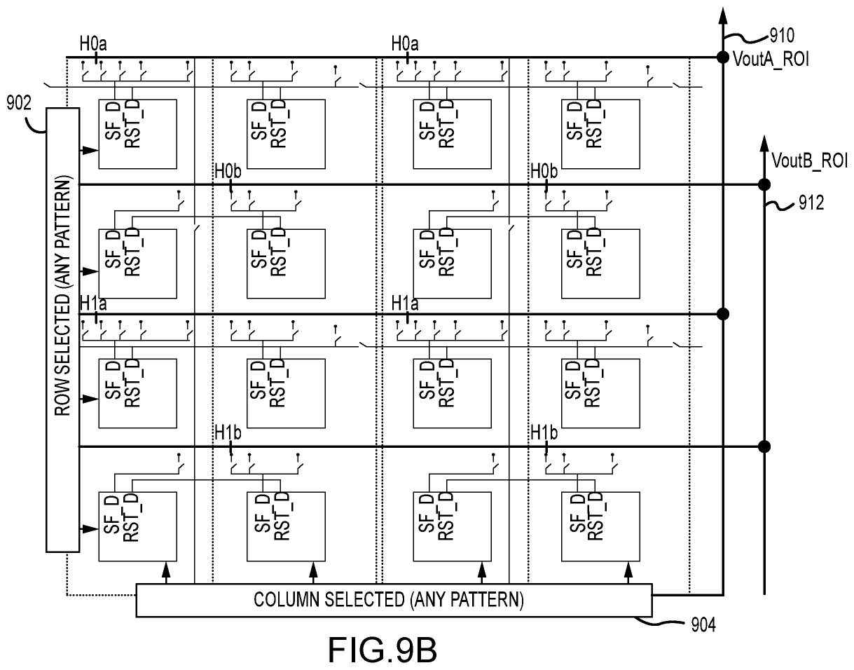

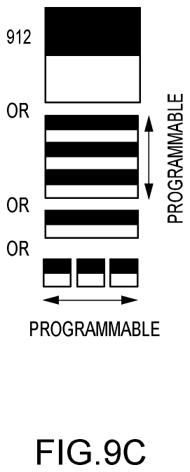

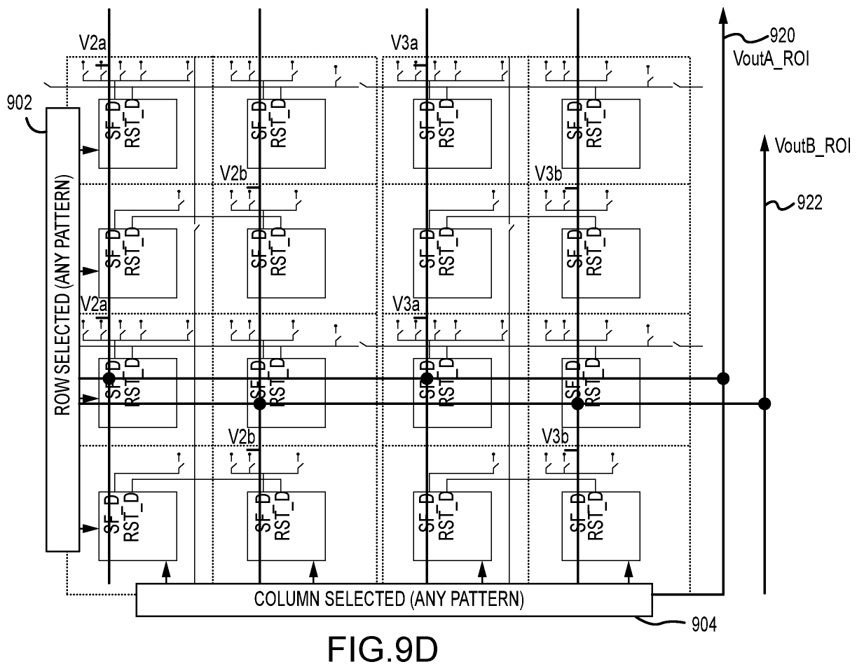

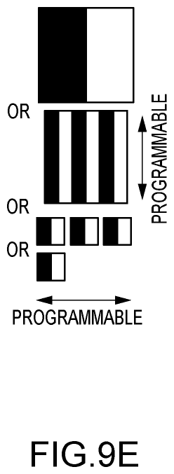

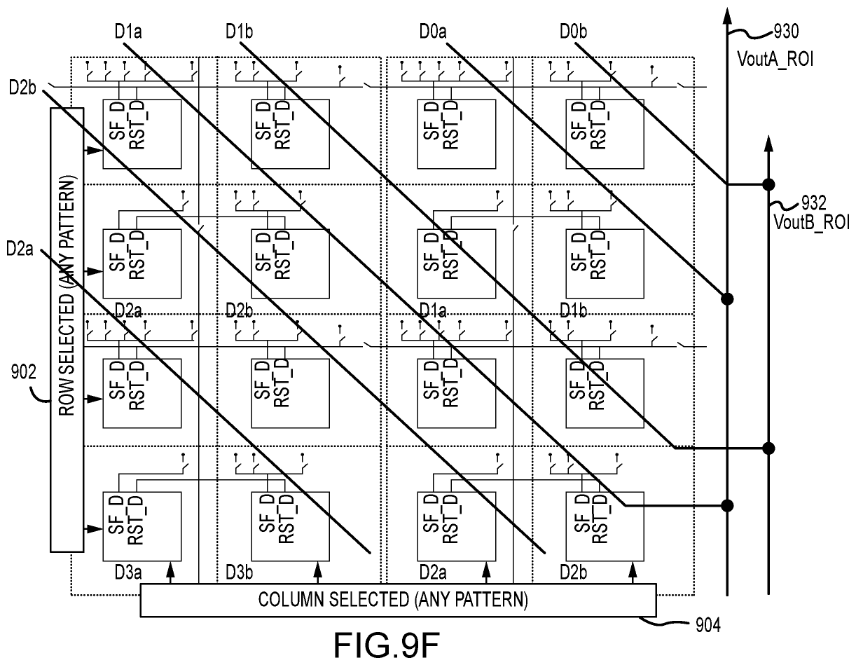

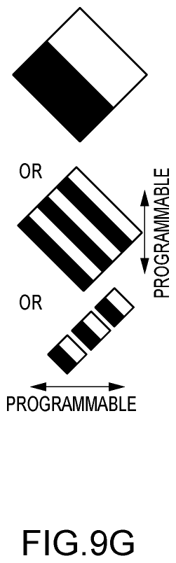

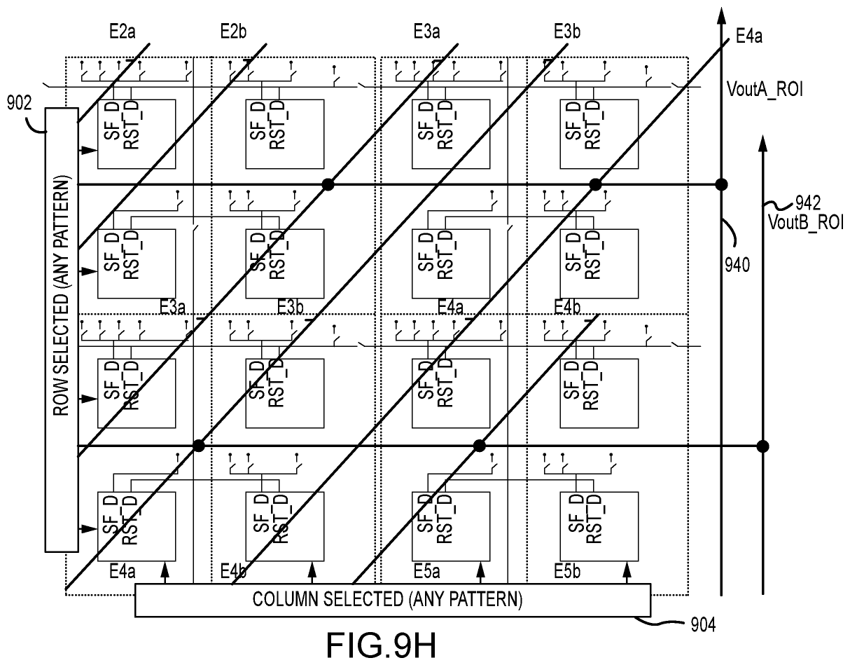

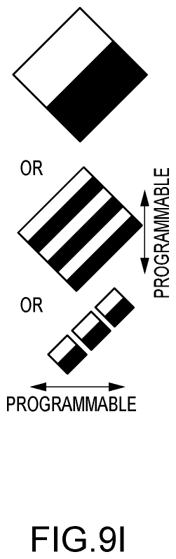

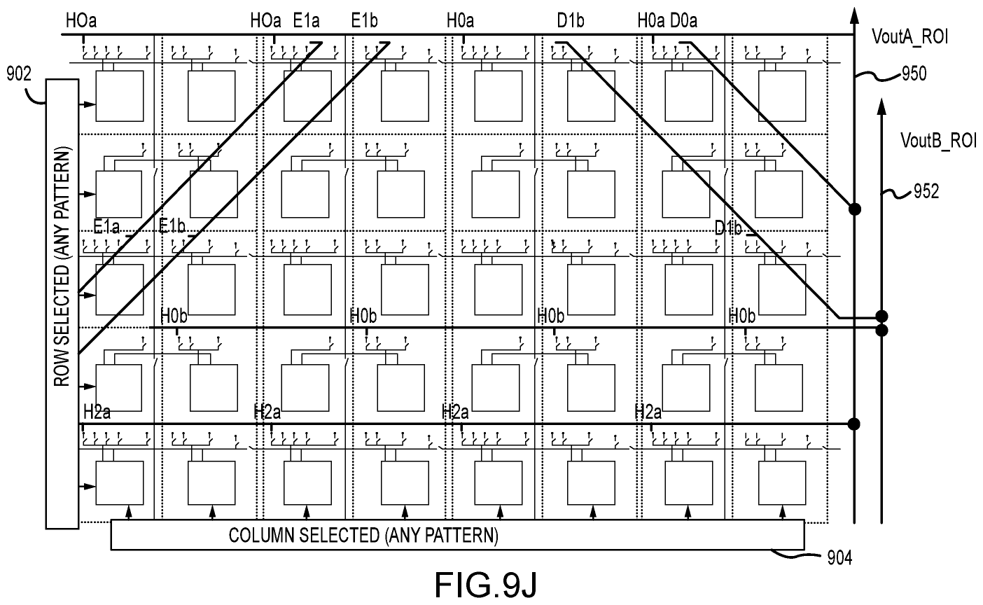

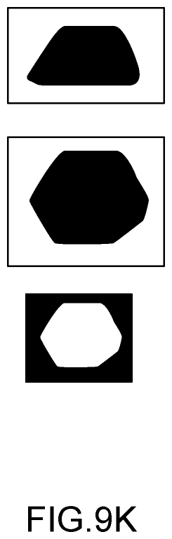

The circuitry of FIG. 7A may optionally be operated as follows. First, voltage VoutA_ROI on the shared SF_D nodes may be coupled to the switch capacitor integrator via path 602. Amplifier 622 may then be auto-zeroed with the SF_D nodes connected in a selected configuration without power (i.e., the FD nodes may initially be at the reset level). After auto-zero operations, light may be collected at the pixels and the resulting generated charge may then be sampled onto floating diffusion nodes FD1, FD2, and FD3. The magnitude of output Vneuron can then be measured as the integrating capacitor Cint responds to the FD nodes pulling down the amplifier negative input, which in turn increases Vneuron. Optionally, a differential integrator may be used to compare with negative weight features. Without applying autozero again, the same measurement of Vneuron can be repeated while Cint is flipped around for detecting feature changes in the analog domain (sometimes referred to as a smart event). If desired, other configurations are selectable for a combination of horizontal, vertical, and diagonal SF_D connections (see, e.g., FIGS. 9A-9K).

FIG. 7B is a diagram showing an illustrative differential readout configuration for combining positive and negative weighted pixel values (or to otherwise compute the difference between two different pixel groups). As shown in FIG. 7B, a first group of pixels 702 may be used to generate a first ROI voltage VoutA_ROI on shared SF_D path 602A, whereas a second group of pixels 704 may be used to generate a second ROI voltage VoutB_ROI on shared SF_D path 602B. First SF_D path 602A may be selectively coupled to the negative (−) input terminal of differential amplifier 622 in integrator block 620′ via local ROI switch 660A and output selection switch 662A. Second SF_D path 602B may be selectively coupled to the positive (+) input terminal of differential amplifier 622 via local ROI switch 660B and output selection switch 662B.

Voltage changes in VoutA_ROI may be integrated using integrating capacitor Cintp coupled to the negative input of amplifier 622, whereas voltage changes in VoutB_ROI may be integrated using integrating capacitor Cintn coupled to the positive input of amplifier 622. Configured in this way, amplifier 622 may produce at its differential output a result that is equal to the difference between Vneuron(p) and Vneuron(n). As an example, Vneuron(p) may represent the total signal value associated with the positively weighted pixels, whereas Vneuron(n) may represent the total signal value associated with the negatively weighted pixels. As another example, Vneuron(p) and Vneuron(n) may represent the total signal values associated with different pixel groups, and the difference between the two values may be used for edge/feature detection. Although the example of FIG. 7B illustrates a differential implementation of FIG. 7A, this differential integrating scheme may similarly be extended and applied to the technique described in connection with FIGS. 6A-6C.

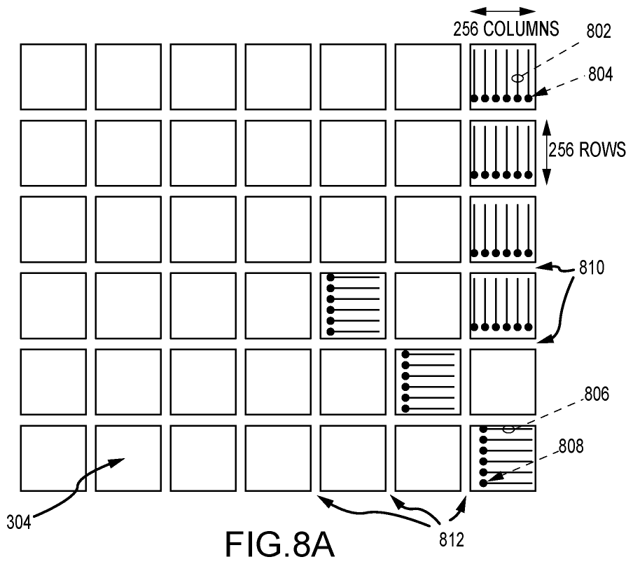

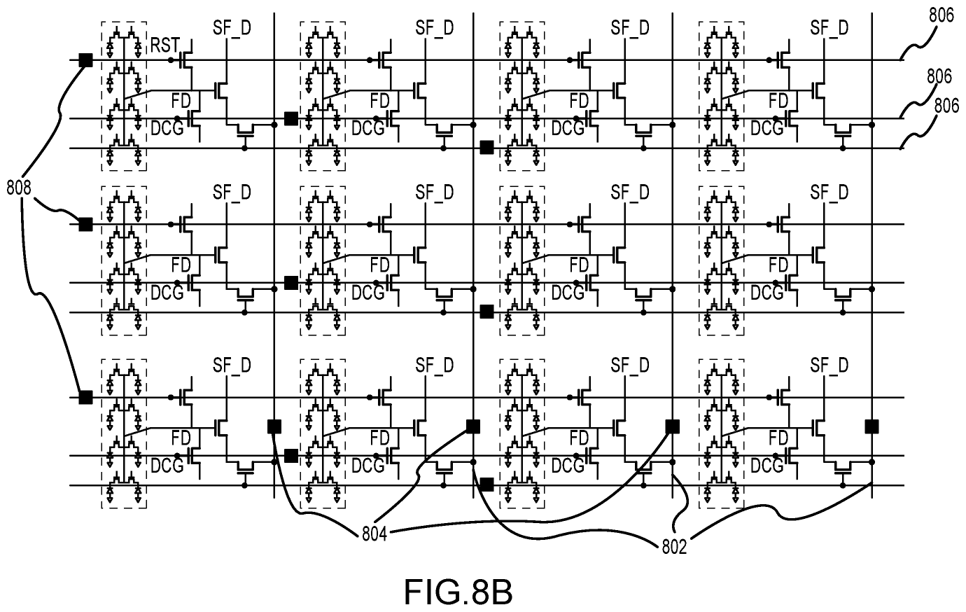

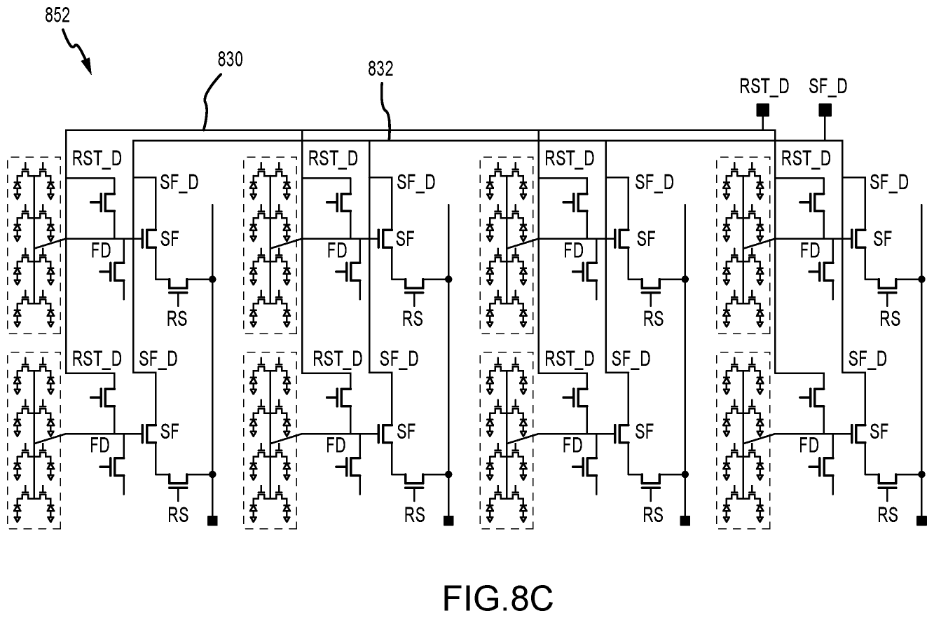

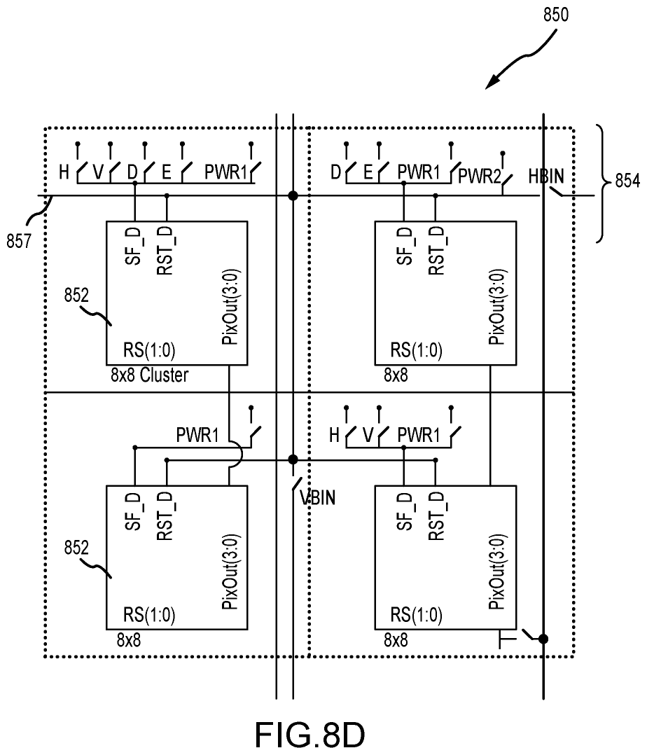

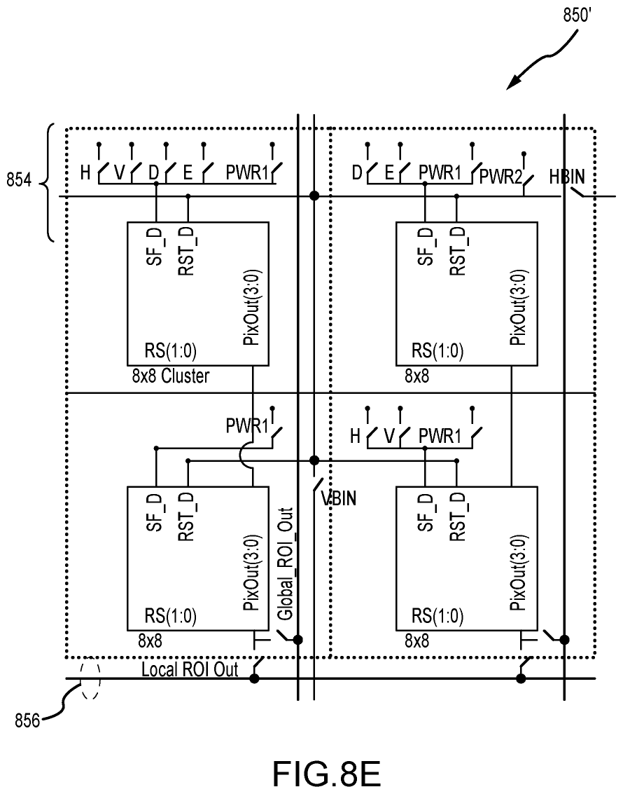

FIG. 8A is diagram illustrating how pixel tiles 304 may be coupled to corresponding ROI control logic formed within stacked analog feature extraction die 204. As described above in connection with FIG. 3, the ROI control logic, routing connections and switches may be formed immediately below each tile 304 in the stacked analog feature extraction die to control the associated pixels in the ROI overhead and to route the signals to periphery circuits on the intermediate die (sometimes referred to as the ROI controller die). Lines 802 may represent the pixel output routing per column in the top image sensor die, and connections 804 may represent the die-to-die bond connection to the ROI controller/processor stacked below the top image sensor die. The pixel output routing per column may end at the edge of each tile 304 and should not continue or extend to another ROI/tile (i.e., column routing lines 802 do not traverse tile gaps 810). Similarly, horizontal lines 806 may represent the pixel control routing per row in the top image sensor die, and connections 808 may represent the die-to-die bond connection to the ROI controller/processor stacked below the top image sensor die. The pixel control routing row may end at the edge of each ROI and should not continue or extend to another tile (i.e., row routing lines 806 do not traverse tile gaps 812).

FIG. 8B is a diagram illustrating how pixel row control lines 806 and column output lines 802 may be coupled to the ROI control logic within the stacked analog feature extraction die. As shown in FIG. 8B, the various row control lines 806 (e.g., row lines controlling the reset transistors, the DCG transistors, the row select transistors, etc.) may be coupled to input-output pins 808, which represent a hybrid bond connection point linking the top image sensor die to the intermediate analog feature extraction die stacked below. The various pixel column lines 802 may be coupled to pins 804, which represent a hybrid bond connection point linking the top image sensor die to the intermediate analog feature extraction die stacked below. In other words, boxes 804 and 808 may represent the physical location of the die-to-die connections.

FIG. 8C is a diagram of an illustrative 8×8 pixel cluster 852. A shown in FIG. 8C, the RST_D nodes of each image pixel in the cluster are interconnected via a reset drain coupling path 830, whereas the SF_D nodes of each image pixel in the cluster are interconnected via a source follower drain coupling path 832. The RST_D terminals may be selectively shorted together to perform charge binning (e.g., the RST_D nodes of pixels along the same row may be coupled together to perform horizontal binning and/or the RST_D nodes of pixels along the same column may be coupled together to perform vertical binning). On the other hand, the SF_D terminals may be selectively shorted together to perform feature extraction as described in connection with FIGS. 6-7.

FIG. 8D is a diagram of an illustrative ROI unit cell 850. In the example of FIG. 8D, each ROI unit cell 850 may include four 8×8 pixel clusters 852 that share the various switch networks described in connection with FIG. 4A. In the example of FIG. 8D, each cluster 852 may have a different number of SF_D switches. For example, the top left cluster may be coupled to five SF_D switches while the top right cluster may only be coupled to three SF_D switches. This is merely illustrative. If desired, each cluster 852 may be coupled to any suitable number of SF_D switches.

The four pixel clusters 852 within ROI unit cell 850 may have the RST_D terminals coupled together via path 857. Configured in this way, the four pixel clusters in cell 850 may be coupled to the pixel clusters in a neighboring ROI cell column by selectively turning on a horizontal binning switch HBIN and/or may be coupled to the pixel clusters in a neighboring ROI cell row by selectively turning on a vertical binning switch VBIN. The vertical/horizontal binning switches may be formed in the intermediate die 204 (FIG. 2).

FIG. 8E is a diagram of another ROI cell 850′ that can be formed at the bottom of each ROI cell column. As shown in FIG. 8E, ROI cell 850′ may be configured to route the pixel output from the ROI cell to a global pixel output bus Global_ROI_Out or to a common local/serial output line Local_ROI_Out (see local serial output line 856).

FIG. 9A is a diagram illustrating how row and column ROI selection can be controlled using row shift registers 902 and column shift registers 904 along with additional logic gates in accordance with an embodiment. For example, row shift registers 902 may be configured to output control signals to the row select transistors within each pixel cluster. Column shift registers 904 may be configured to output control signals to the local ROI column switch (see, e.g., switch 660 and/or switch 662 in FIG. 6A, switch 663 in FIG. 7A, and switches 660A/B and 662A/B in FIG. 7B) to control the local ROI connections. The row selection and column selection shift registers for controlling the various switch networks within each ROI unit cell may all be formed in the intermediate analog die 204.

The illustrative kernel operations described above in relation to FIG. 5 focus on smaller 3×3 or 5×5 regions and are not intended to limit the scope of the present embodiments. In general, the circuitry, methods, and techniques described herein may be applied to any (bigger) shapes of weight pixels. The extension to non-square ROIs will allow detection for bigger or more complex-looking features. FIGS. 9A-9K illustrate the architecture for supporting variable shape detection.

FIG. 9A is a diagram illustrating how row and column ROI selection can be controlled using the row and column shift registers (e.g., registers 902 and 904 in FIG. 9A) along with additional logic gates. The row selection and column selection shift registers for controlling the various switch networks within each ROI unit cell may all be formed in the intermediate analog die 204.

FIG. 9B is a diagram illustrating how row and column ROI selection can be configured to support horizontal feature signal detection. Control signals H0a, H0b, H1a, H1b, H2a, and H2b enable the switches to connect to outputs VoutA_ROI and VoutB_ROI. As shown in FIG. 9B, the upper clusters in each ROI unit cell are coupled together via horizontal lines and routed out as VoutA_ROI on path 910, whereas the lower clusters in each ROI unit call are coupled together via horizontal lines and routed out as VoutB_ROI on path 912. FIG. 9C is a diagram illustrating exemplary shapes that can be detected using the ROI selection scheme of FIG. 9B. As shown in FIG. 9C, the grouping of rows and the segmentation of the rows are optionally programmable to enable detection of various types of horizontally oriented edges or shapes.

FIG. 9D is a diagram illustrating how row and column ROI selection can be configured to support vertical feature signal detection. As shown in FIG. 9D, the left clusters in each ROI unit cell are coupled together via vertical lines and routed out as VoutA_ROI on path 920, whereas the right clusters in each ROI unit call are coupled together via vertical lines and routed out as VoutB_ROI on path 922. FIG. 9E is a diagram illustrating exemplary shapes that can be detected using the ROI selection scheme of FIG. 9D. As shown in FIG. 9E, the grouping of columns and the segmentation of the column are optionally programmable to enable detection of various vertically oriented edge/shape types.

FIG. 9F is a diagram illustrating how row and column ROI selection can be configured to support a +45° diagonal feature signal detection. As shown in FIG. 9F, a first diagonal group of pixels are coupled together and routed out as VoutA_ROI on path 930, whereas a second diagonal group of pixels are coupled together and routed out as VoutB_ROI on path 932. The two groups of pixels may be interleaved or alternating stripes in the diagonal direction. FIG. 9G is a diagram illustrating exemplary shapes that can be detected using the ROI selection scheme of FIG. 9F. As shown in FIG. 9G, the grouping of diagonal pixels and the segmentation of the diagonal stripes are optionally programmable to enable detection of various types of diagonally oriented edges or shapes.

FIG. 9H is a diagram illustrating how row and column ROI selection can be configured to support a −45° diagonal feature signal detection. As shown in FIG. 9H, a first diagonal group of pixels are coupled together and routed out as VoutA_ROI on path 940, whereas a second diagonal group of pixels are coupled together and routed out as VoutB_ROI on path 942. The two groups of pixels may be interleaved or alternating stripes in the diagonal direction. FIG. 9I is a diagram illustrating exemplary shapes that can be detected using the ROI selection scheme of FIG. 9H. As shown in FIG. 9I, the grouping of diagonal pixels and the segmentation of the diagonal stripes are optionally programmable to enable detection of various types of diagonally oriented edges or shapes.

FIG. 9J is a diagram illustrating how row and column ROI selection can be configured to detect a predetermined shape. As shown in FIG. 9J, a first subset of pixels are coupled together and routed out as VoutA_ROI on path 950, whereas a second subset of pixels are coupled together and routed out as VoutB_ROI on path 952. The two pixel subsets may demarcate or outline a non-regular or some other predetermined edge or shape. FIG. 9K is a diagram illustrating exemplary shapes that can be detected using the ROI selection scheme of FIG. 9J. As shown in FIG. 9K, detection of different irregular shapes having multiple edges angled at various orientations may be supported in this way.

The foregoing is merely illustrative of the principles of this invention and various modifications can be made by those skilled in the art. The foregoing embodiments may be implemented individually or in any combination.

What is claimed is:

1. Imaging circuitry, comprising:
a first pixel having a first source follower transistor with a first source follower drain terminal;
a second pixel having a second source follower transistor with a second follower drain terminal;
region of interest (ROI) switching circuitry configured to couple the first source follower drain terminal to a charge sensing line and to couple the second source follower drain terminal to the charge sensing line when performing feature extraction operations; and
an integrating circuit coupled to only one of the first and second pixels to compute a feature result for the feature extraction operations.

2. The imaging circuitry of claim 1, wherein the first and second pixels are part of an array of pixels formed in an image sensor die.

3. The imaging circuitry of claim 2, wherein the first and second pixels are part of different rows in the array.

4. The imaging circuitry of claim 2, wherein the first and second pixels are part of different columns in the array.

5. The imaging circuitry of claim 2, wherein the ROI switching circuitry and the integrating circuit are formed in a feature extraction die, and wherein the image sensor die is stacked directly on top of the feature extraction die.

6. The imaging circuitry of claim 1, wherein the first pixel also has a first reset transistor, wherein the second pixel also has a second reset transistor, and wherein the ROI switching circuitry leaves the first and second reset transistors electrically floating when coupling the first and second source follower drain terminals to the charge sensing line.

7. The imaging circuitry of claim 1, wherein the first pixel also has a first reset transistor, wherein the second pixel also has a second reset transistor, and wherein the ROI switching circuitry couples the first and second reset transistors to a positive power supply terminal when coupling the first and second source follower drain terminals to the charge sensing line.

8. The imaging circuitry of claim 1, wherein the first pixel also has a first row select transistor, wherein the second pixel also has a second row select transistor, and wherein only one of the first and second row select transistors is turned on for computing the feature result.

9. The imaging circuitry of claim 1, wherein the integrating circuit comprises:
an amplifier having first and second inputs;
an integrating capacitor;
a first set of switches configured to couple the integrating capacitor to the second input of the amplifier in a first configuration; and
a second set of switches configured to couple the integrating capacitor to the second input of the amplifier in a second configuration having an opposite polarity than the first configuration.

10. The imaging circuitry of claim 1, wherein the first set of switches remain on when computing successive feature results.

11. The imaging circuitry of claim 10, wherein the integrating circuit is coupled to only one of the first and second pixels to compute an additional feature result for the feature extraction operations, and wherein the feature result and the additional feature result are compared in the digital domain to detect a feature change.

12. The imaging circuitry of claim 1, wherein the first and second sets of switches are toggled when computing successive feature results.

13. The imaging circuitry of claim 12, wherein the integrating circuit is coupled to only one of the first and second pixels to compute an additional feature result for the feature extraction operations, and wherein the additional feature result is compared with a common mode voltage in the analog domain to detect a feature change.

14. The imaging circuitry of claim 1, wherein the ROI switching circuitry is configured during the feature extraction operations to detect shapes selected from the group consisting of: horizontally oriented shapes, vertically oriented shapes, diagonally oriented shapes, and irregular shapes.

15. Imaging circuitry, comprising:
a first pixel having a first source follower transistor with a first source follower drain terminal;
a second pixel having a second source follower transistor with a second follower drain terminal;
switching circuitry configured to couple the first source follower drain terminal to a sensing line and to couple the second source follower drain terminal to the sensing line when performing feature extraction operations; and
an integrating circuit coupled to the sensing line to compute a feature result for the feature extraction operations.

16. The imaging circuitry of claim 15, wherein the first and second pixels are part of an array of pixels formed in an image sensor die, wherein the switching circuitry and the integrating circuit are formed in a feature extraction die, and wherein the image sensor die is stacked directly on top of the feature extraction die.

17. Imaging circuitry, comprising:
a first group of pixels having source follower drain terminals coupled to a first charge sensing line;
a second group of pixels having source follower drain terminals coupled to a second charge sensing line; and
an integrating circuit having a first input terminal coupled to the first charge sensing line and a second input terminal coupled to the second charge sensing line when performing feature extraction operations.

18. The imaging circuitry of claim 17, further comprising:
a first set of switches configured to couple the first charge sensing line to the first input terminal of the integrating circuit; and
a second set of switches configured to couple the second charge sensing line to the second input terminal of the integrating circuit.

19. The imaging circuitry of claim 18, wherein the first and second groups of pixels are part of an array of pixels formed in an image sensor die, wherein the integrating circuit and the first and second sets of switches are formed in a feature extraction die, and wherein the image sensor die is stacked directly on top of the feature extraction die.

20. The imaging circuitry of claim 17, wherein the integrating circuit further comprises:
an amplifier having a first amplifier input that serves as the first input terminal of the integrating circuit and a second amplifier input that serves as the second input terminal of the integrating circuit;
a first integrating capacitor that is coupled to the first amplifier input and that is configured to integrate charge from the first charge sensing line; and
a second integrating capacitor that is coupled to the second amplifier input and that is configured to integrate charge from the second charge sensing line, wherein the amplifier has a differential output on which a feature difference result between the first and second groups of pixels is generated.
